(19) United States
(12) Patent Application Publication
(10) Pub. No.: US 2006/0099351 A1
(43) Pub. Date: May 11, 2006

(54) Aggregate floor coating and method for applying same

(75) Inventors: Bruce F. Field, Golden Valley, MN (US); Robert J. Tweedy JR., Coon Rapids, MN (US)

Correspondence Address: MUETING, RAASCH & GEBHARDT, P.A., P.O. BOX 581415, MINNEAPOLIS, MN, 55458, US

(73) Assignee: TENNANT COMPANY, MINNEAPOLIS, MN (US)

(21) Appl. No.: 11/311,947

(22) Filed: Dec. 20, 2005

Related U.S. Application Data
(62) Division of application No. 10/324,383, filed on Dec. 19, 2002.
(60) Provisional application No. 60/345,549, filed on Jan. 3, 2002.

(51) Int. Cl. B05D 1/36

(52) U.S. Cl. 427/487; 427/402

(57) ABSTRACT

The invention is directed to an aggregate floor coating and method/system for applying the same. In one embodiment, a base layer of epoxy or equivalent material may be applied to a prepared floor surface. Prior to curing of the base layer, a quantity of aggregate flooring material, e.g., quartz particles, may be broadcast over the exposed surface of the base layer. Upon curing of the base layer, an ultraviolet (UV)-curable topcoat layer may be applied. Exposure of the UV-curable topcoat layer to one or more specific wavelengths of UV energy results in fast curing of the topcoat layer, permitting quick resumption of floor traffic. Coatings of the present invention provide numerous advantages, such as allowing application of aggregate floor coatings in well-lit, e.g., sun-exposed areas.

### RELATED APPLICATIONS

This application claims the benefit of U.S. Provisional Application No. 60/345,549, filed 3 Jan. 2002, which is hereby incorporated herein by reference in its entirety.

### TECHNICAL FIELD

The present invention relates generally to floor coatings and, more specifically, to aggregate floor coatings, such as those that may provide decorative and/or no-slip surfaces, and methods for applying the same to a floor surface.

### BACKGROUND

Aggregate floor coatings are generally known in the art. Generally speaking, these coatings include one or more particles, e.g., grits, embedded or otherwise contained within one or more layers of the floor coating. Aggregate floor coatings are typically used to provide a decorative and/or slip-resistant floor surface.

To apply the aggregate floor coating to the floor surface, the floor surface is typically prepared (e.g., repaired, cleaned, etched) and a base layer, e.g., an epoxy material, is applied thereto. The base layer is applied as a liquid coating that may be subsequently cured to form a hardened layer. Particles of the desired aggregate material, e.g., quartz granules, are broadcast over the at least partially uncured base layer. After curing of the base layer, a topcoat layer, which is also typically applied as a curable liquid, may be applied over the particles of aggregate material to seal the underlying base layer and to provide a durable, stain-resistant layer over the entire floor surface. Once the topcoat layer is completely cured, normal floor traffic may resume. Curing of both the base layer and the topcoat layer is generally achieved through thermal treatment and/or exposure to ambient conditions.

Aggregate floor coatings provide numerous advantages. For example, these coatings may protect the underlying floor surface from damage associated with dirt, wear, exposure, or spillage. With the use of decorative particles of aggregate material, e.g., colored or prismatic quartz particles, these coatings may also provide a more aesthetically pleasing floor appearance and improve overall ambient lighting (e.g., from increased floor reflection). Moreover, aggregate floor coatings, with their textured appearance, may hide floor surface imperfections, e.g., floor peaks and valleys, more effectively than smooth finished coatings. The three-dimensional shape of the particles of aggregate material also provide a roughened floor surface that, for example, improves traction. Still further, aggregate floor coatings may simplify floor cleaning procedures.

However, even with these advantages, drawbacks exist. For instance, cure times for many of the materials, e.g., the topcoat, can be substantial, e.g., anywhere from several hours to days. As a result, floor traffic may be significantly interrupted during the floor coating process. While such interruptions may be acceptable in limited circumstances, long cure times may make some application of these coatings difficult, or, in some instances, impractical.

Another problem with existing aggregate floor coatings is subsequent discoloration, e.g., yellowing, of the underlying epoxy base layer due to excessive light exposure. As a result, use of aggregate floor coatings in heavily lit, e.g., sun-exposed, areas is typically avoided.

Still another problem with current aggregate floor coatings involves repair of damaged areas of the topcoat layer. More specifically, due to the high cure times associated with current topcoat materials, any damaged area is typically isolated after topcoat repair to allow adequate time to cure. As a result, repairing damage to even a small area of the topcoat layer may necessitate a significant interruption (e.g., several hours to days) of floor traffic in the immediate vicinity of the repair.

### SUMMARY

The present invention provides an aggregate floor coating and a floor coating method. Coatings and methods in accordance with the present invention may offer substantially reduced cure times, permitting rapid resumption of normal floor traffic. Moreover, coatings and methods in accordance with the present invention may provide a topcoat layer that provides ultraviolet protection to the underlying base layer and aggregate material, thereby reducing yellowing of the same. Coatings and methods of the present invention may also simplify repair of the topcoat layer by permitting rapid curing of the same.

In one embodiment, a floor coating is provided. The floor coating includes a cured base layer formed from a curable base layer material, and an aggregate flooring material associated with the cured base layer. An ultraviolet-cured topcoat layer is also included over the cured base layer and the aggregate flooring material.

In another embodiment, a method for applying a coating to a floor surface is provided, wherein the method includes applying at least one curable base layer material and particles of aggregate material to the floor surface, and curing the at least one curable base layer material to form an at least partially cured base layer. An ultraviolet-curable topcoat layer material is applied over the at least partially cured base layer and the particles of aggregate material; and the ultraviolet-curable topcoat layer material is cured, via exposure to ultraviolet energy, to form an ultraviolet-cured topcoat layer.

In yet another embodiment, a method for applying a coating to a floor surface is provided. The method includes applying a first curable base layer material to the floor surface, and distributing a first aggregate material over an upper surface of the first curable base layer material. A first ultraviolet-curable topcoat layer material may be applied over the first aggregate material and the first curable base layer material, and the first ultraviolet-curable topcoat layer material may be cured by exposure to ultraviolet energy to form a first ultraviolet-cured topcoat layer.

In still yet another embodiment, a method for applying a coating to a floor surface is provided in which the method includes mixing a curable base layer material with an aggregate flooring material to form a slurry. The slurry is then applied to the floor surface and an ultraviolet-curable topcoat layer material is applied over the slurry. The ultraviolet-curable topcoat layer material may be cured by application of ultraviolet energy from an ultraviolet energy source.

The above summary of the invention is not intended to describe each embodiment or every implementation of the present invention. Rather, a more complete understanding of the invention will become apparent and appreciated by reference to the following detailed description and claims in view of the accompanying drawing.

### BRIEF DESCRIPTION OF THE VIEWS OF THE DRAWING

The present invention will be further described with reference to the views of the drawing, wherein:

FIG. 1 is a diagrammatic, cross-section view of an aggregate coating, such as an aggregate floor coating, in accordance with one embodiment of the present invention (layer thicknesses are exaggerated for illustration purposes);

FIG. 2 is a perspective view of an exemplary curing apparatus;

FIG. 3 is a block diagram illustrating an exemplary method of applying an aggregate floor coating of the present invention to a floor surface; and

FIG. 4 is a block diagram representing another exemplary method of applying an aggregate floor coating of the present invention to a floor surface.

### DETAILED DESCRIPTION OF EXEMPLARY EMBODIMENTS

In the following detailed description of exemplary embodiments, reference is made to the accompanying figures of the drawing which form a part hereof, and in which are shown by way of illustration specific embodiments in which the invention may be practiced. It is to be understood that other embodiments may be utilized and structural changes may be made without departing from the scope of the invention.

The instant invention is generally directed to aggregate floor coatings and methods for applying the same to a floor surface. The aggregate floor coating ideally includes an aggregate flooring material therein. As used herein, “aggregate flooring material” may include most any material, but generally includes materials that provide either or both a particular utility (e.g., no-slip surface) or decorative appearance (e.g., three-dimensional texture or color variation) to the floor surface. To achieve this result, the aggregate flooring material may include particles that provide the floor coating with a three-dimensional texture.

Most any floor surface may benefit from the coatings and methods of the present invention including, for example, concrete, ceramic tile, wood, and vinyl. Moreover, while described herein with reference to floor coatings, those of skill in the art will realize that coatings and methods in accordance with the present invention may be used to coat non-floor surfaces as well. In fact, this invention may find application with most any substrate surface.

Broadly speaking, coatings and methods of the present invention provide an aggregate floor coating having a curable base layer (also referred to herein as “base coating”) covered with an aggregate flooring material. After curing of the base layer, an ultraviolet (UV)curable topcoat layer (also referred to herein as “topcoating”), is then applied over the combined base layer and aggregate flooring material. Subsequent UV illumination of the topcoat layer results in relatively instant curing of the same. Instant curing permits, among other advantages, a substantial reduction in floor traffic interruption. Other advantages of the present invention are described in more detail below.

The term “curable” is used herein to refer to reactive systems that irreversibly solidify upon the application of heat and/or other sources of energy, such as E-beam, ultraviolet, visible, etc., or with time upon the addition of a chemical catalyst, moisture, and the like. The irreversible solidification may involve polymerization, crosslinking, or both.

The term “instant curing” is defined herein to include substantial curing of the coating material relatively instantly, e.g., within several seconds or less. “Substantial curing” or “substantially cured” includes most any degree of curing or hardening of the identified coating layer material that results in at least a tack-free (e.g., not wet) coating surface.

For simplicity, embodiments of the present invention are described herein as utilizing quartz granules as the aggregate flooring material. However, other naturally and artificially colored silicas, grits (e.g., sand, silicon carbide, crystallized aluminum oxide), flake materials (e.g., paint flecks or chips or the like), or most any other suitable particulate material (e.g., rubber or plastic fragments) may also be utilized as the aggregate flooring material without departing from the scope of the invention.

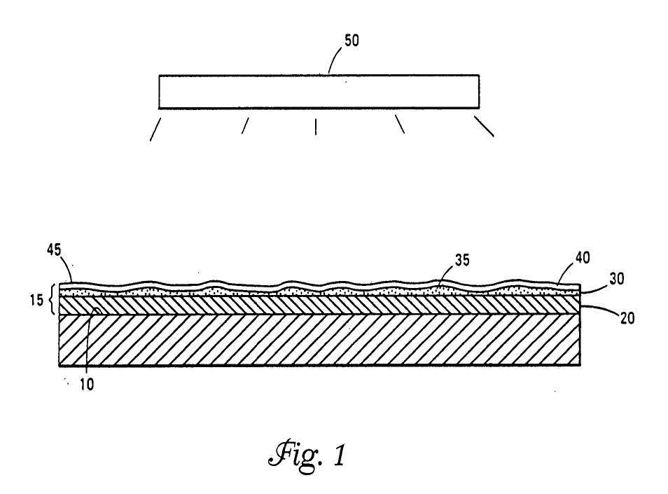

An exemplary floor coating 15 in accordance with the present invention is illustrated in cross section in FIG. 1. Here, a curable, first base layer 20 lies over a substrate surface (e.g., a concrete floor surface 10). The base layer 20 is, in one embodiment, a cured epoxy resin material such as the two-part ECO-MPE/ECO-FSE, (part A)/ECO-MPE/ECO-PT (part B) epoxy resin floor coating product sold by the Tennant Company of Minneapolis, Minn., USA. However, as those of skill in the art will recognize, other curable base layer materials may be used to form the base layer 20.

Where it is helpful to describe the invention, the term “base layer material” is used to identify the base layer 20 in its uncured, liquid form, e.g., as it exists prior to and/or during application to the floor surface 10, while the term “base layer” is used to identify the resulting layer 20 after deposition, e.g., the base layer material after it has been partially or fully cured to form the layer structure. No other distinction is intended by the use of these separate terms and thus both “base layer” and “base layer material” are associated hereby with reference numeral 20 of FIG. 1.

The base layer material 20 may be curable by exposure to one or more of heat or other energy, e.g., ambient temperature, humidity, and/or visible light.

A layer 30 of aggregate flooring material, e.g., quartz granules 35 such as ECO-DQF (part C) sold by Tennant Co., may at least partially cover the upper surface of the base layer 20. As further explained below, the layer 30 is, in one embodiment, applied prior to complete curing of the base layer 20. As a result, at least some of the granules 35 may at least partially embed into the base layer 20 or otherwise become substantially secured in place upon subsequent curing of the base layer.

After curing of the base layer 20 (with the granules 35 thereon), one or more additional base layers and corresponding layers 30 may be applied (not shown) to increase total floor coating thickness.

A UV-curable topcoat layer 40, such as ECO-DQF/UV sold by Tennant Co., may then be deposited over the aggregate flooring material layer 30. The topcoat layer material preferably includes, as further described below, photoinitiators that are reactive to one or more particular, predetermined UV wavelengths. As a result, application of UV energy at these particular wavelengths from a UV source 50, may result in relatively instant curing of the topcoat layer material.

Where it is helpful to describe the invention, the term “topcoat layer material” may sometimes be used to identify the topcoat layer in its uncured, liquid form, e.g., as it exists prior to and/or during application, while the term “topcoat layer” is used to identify the resulting layer 40 after deposition, e.g., the topcoat layer material after it has been partially or fully cured to form the layer structure. No other distinction is intended by the use of these separate terms and thus both “topcoat layer” and “topcoat layer material” are hereby associated with reference numeral 40 of FIG. 1.

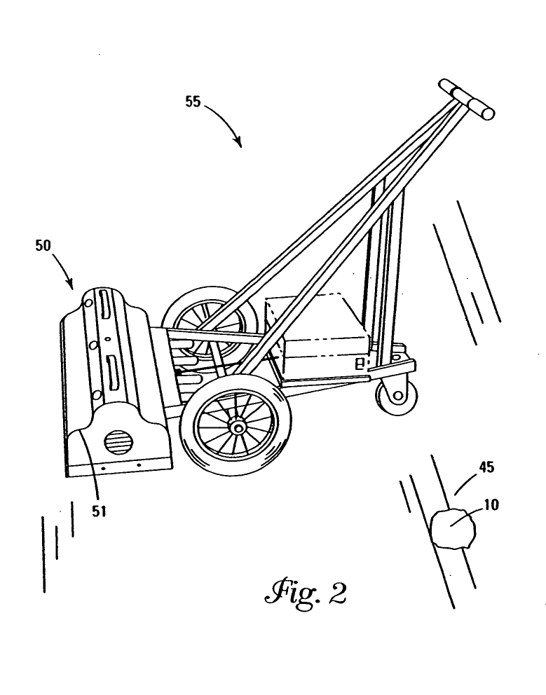

An exemplary UV curing apparatus 55 having UV source 50 attached thereto is illustrated in FIG. 2. For a discussion of other exemplary apparatus that may be used to cure the topcoat layer 40, see, e.g., U.S. Pat. No. 6,096,383 to Berg et al., or copending application Ser. No. 10/086,790, entitled “Methods and Apparatus for Curing Floor Coatings Using Ultraviolet Radiation.” Other UV curing devices, including other push-powered or self-propelled, walk-behind or riding devices, as well as handheld devices, may also be used.

While a preferred topcoat layer 40 is described herein as ECO-DQF/UV, other UV-curable layer materials (and correspondingly, other UV curing apparatus) may certainly be used without departing from the scope of the invention. In fact, the topcoat layer 40 of the present invention may include, for example, most any UV-curable urethane-based copolymer. For instance, in another embodiment, the topcoat layer 40 is produced by NorIand Products, Inc. of New Brunswick, N.J. (USA), under the designation SW3. Another exemplary topcoat layer material is made by Summers Optical of Fort Washington, Pa. (USA), and sold under the designation VTC-2. Most any other material or substance, e.g., acrylates, epoxy acrylates, and urethane acrylates, that polymerizes under application of UV radiation may be used as a topcoat layer material without departing from the scope of the invention.

In addition to being UV-reactive, the material of the topcoat layer 40 may include conventional curing agents which permit curing by exposure to ambient light or sunlight. As a result, floor areas missed or not completely cured by the UV curing apparatus 55, e.g., corners and edges adjacent a wall or other obstacle, may still cure completely over time.

Various additives may optionally be included in the material of the topcoat layer 40. For example, in many applications, protection against static electricity is desirable. In these instances, electrically conductive additives, e.g., indium tin oxide, nickel-coated graphite, silver-coated graphite, and/or gold-coated graphite, may be added to the topcoat layer material. These additives may be beneficial where they provide the topcoat layer 40 with electrically conductive properties which eliminate, or at least reduce, static electricity. These additives preferably do not interfere with the curing process and typically will not affect the color of the topcoat layer 40. Examples of some other additives which may be included with the topcoat layer material include colorants (powder or liquid form) and texturing components.

To promote quick curing of the topcoat layer 40, topcoat layer materials of the present invention include components that are preferably reactive to, i.e., cured by, UV radiation of at least two different wavelengths. For example, UV radiation at a first wavelength of about 350 nanometers (nm) to about 380 nm and, more preferably, at a wavelength of about 365 nm provides what is known as deep curing. Deep curing cures that portion of the topcoat layer 40 closest to the floor surface and furthermore promotes adhesion of the topcoat layer with underlying layers, e.g., base layer 20 and aggregate flooring material layer 30 of FIG. 1. Subsequent to, or simultaneous with, the application of the first wavelength, UV radiation at a second wavelength of about 240 nm to about 270 nm and, more preferably, about 254 nm is applied. This second wavelength of UV radiation provides surface curing and assists in complete curing of the topcoat layer 40.

In one embodiment, the UV source 50 (see FIG. 1) may include one or more UV lamps (not shown) located under a hood 51 (see FIG. 2). Such lamps may preferably be medium pressure mercury flood lamps having either a ballast incorporated on the lamp itself (self-ballasted), or an external ballast.

Ideally, each lamp is selected such that the dopants therein provide energy “spikes” at the desired wavelengths, e.g., at the specific wavelengths that activate the UV-reactive components in the topcoat layer 40. Stated another way, the lamps are matched with the topcoat layer material in that a significant portion of the UV energy emitted by each lamp occurs at the desired wavelengths, e.g., at 365 nm and 254 nm.

While the topcoat layer material is described as responsive to specific UV wavelengths, other wavelengths are certainly possible. In fact, topcoat layer materials responsive to most any wavelengths are possible, provided that the UV-reactive components within the topcoat layer material are selected to match the particular wavelengths of UV radiation emitted by the UV radiation source 50. By matching the topcoat layer material to the UV radiation in this way, relatively instantly curing of the topcoat layer 40 may occur with only minimal power input. Low power curing offers numerous advantages including, for example, reduced heat and, thus, less opportunity to overcure or “burn” the topcoat layer 40.

An exemplary UV source 50 operates with low power, e.g., effective power consumption of no more than about 75 watts per inch of cured coating width. “Cured coating width” refers to the transverse, e.g., side-to-side, “line” of effective cure width. For example, effective power consumption by the UV source 50 may be about 25 to about 75 watts per inch of cured coating width and, more preferably, about 40 to about 60 watts per inch of cured coating width.

In one embodiment, the UV source 50 includes three separate lamps (not shown) under the hood 51 (FIG. 2) that effectively illuminate a width of about 24 inches (in). The UV source 50 has a total effective power input of about 1200 watts, or about 50 watts per inch of cured coating width. The UV source 50 is preferably positioned above the floor surface 10 (see FIG. 1) at a working height that ensures sufficient UV radiation is delivered to the floor (e.g., positioned about 4 in to about 7 in above the floor surface). Experiments suggest that this configuration allows curing of the topcoat layer 40, without burning, at travel speeds less than 3 inches/second (in/s). In addition, this configuration may result in substantial curing at speeds up to and beyond 8 in/s.

The resulting cured floor surface 45 (see FIG. 1) preferably has a decorative, three-dimensional appearance due in part to the granules of layer 30. The extent of this three-dimensional appearance may be at least partially controlled by selection of the aggregate size of the granules 35, as well as the characteristics of the topcoat layer 40 (e.g., viscosity).

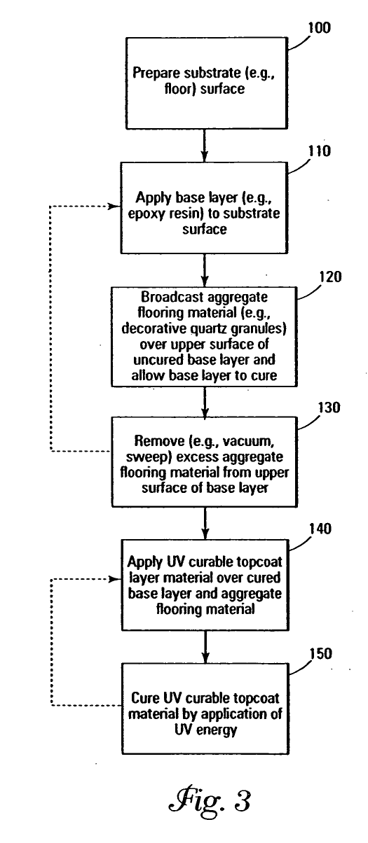

FIGS. 3 illustrates a method for applying a floor coating in accordance with one embodiment of the present invention. An initial step of cleaning and preparing the substrate surface, e.g., the floor surface 10 of FIG. 1, is identified at reference numeral 100. This preparation may be accomplished in accordance with procedures known in the art. For example, detergent scrubs and chemical etching may be utilized if dictated by floor condition.

Other preparations may vary depending on the floor type and condition. For example, in some situations, a previously applied floor coating must first be removed before an aggregate floor coating in accordance with the present invention may be applied. Removal may be accomplished in any number of ways. For instance, the coating may be softened with a solvent stripper and manually scraped off. More preferably, products such as those sold by Tennant Company under the name ECO-PREP may be used (for example, in conjunction with a sanding machine as described in U.S. Pat. No. 4,768,311 to Olson) to remove the old coating and prepare the floor surface. Some floors may further require scrubbing, vacuuming, and/or acid-etching to ensure the floor surface is clean and capable of forming a strong adhesive bond with the new floor coating.

After surface preparation, a base layer (e.g., base layer 20 of FIG. 1) may be applied over the substrate surface at 110. As mentioned above, while most any curable material suitable for forming the desired base layer is within the scope of the invention, epoxy resin materials suitable for floor covering are preferred.

The thickness of the base layer may be selected based upon the particular application. Preferably, thicknesses from about 0.005 in to more than 0.02 in, and more preferably from about 0.01 in to about 0.02 in, provide sufficient substrate protection as well as an acceptably thick base layer for the subsequently applied aggregate particles (the granules 35 of FIG. 1). However, these ranges are not limiting as other thicknesses are certainly possible. For example, where the floor surface is uneven or has some degree of surface variation, an initial “precoat” of epoxy resin (or other material) may be applied to smooth the floor surface prior to application of the base layer. When such a precoat of epoxy resin is applied, the actual thickness of the base layer may be effectively increased by the thickness of the precoat.

Application of the base layer material may be accomplished in accordance with most any technique known in the art. For example, the base layer material may be poured onto the floor and distributed with a squeegee. For thicker base layers, a notched squeegee may be used. A nap roller may be used to remove puddles and lap marks left by the squeegee (“backrolling”). Use of spiked epoxy shoes permits freedom of movement over the wet floor surface. While dependent on the desired thickness of the base layer, backrolling the base layer material such that it covers about 100 feet/gallon (ft²/gal) to about 150 ft²/gal is typical when using the Tennant two-part ECO-MPE/ECO-FSE, (part A)/ECO-MPE/ECO-PT (part B) epoxy resin floor coating mentioned above.

After the base layer material 20 is applied, aggregate flooring material particles, e.g., quartz granules 35 of FIG. 1, may be distributed or broadcasted over an upper surface of the base layer material at 120 (see FIG. 3). The granules 35 that make up the aggregate flooring material are preferably distributed over substantially all of the upper surface of the base layer 20 (i.e., little or no areas of the base layer 20 remain exposed after application of the aggregate flooring material particles) while the base layer is still at least partially uncured.

While not wishing to be limited to any particular granular size, the quartz granules 35 of the Tennant ECO-DQF product may be about 20 U.S. Mesh to about 100 U.S. Mesh (e.g., may have a diameter, or equivalent external dimension, ranging from 0.03 in to 0.006 in) and, more preferably, about 30 U.S. Mesh to about 50 U.S. Mesh (particle diameter of about 0.02 in to about 0.012 in).

To assist in the distribution of particles over the entire surface of the base layer 20, a mechanical blower, e.g., an apparatus similar to the common handheld leaf blower, may be used. Aggregate coverage rates may vary as a function of several factors, e.g., particle size, desired result, etc. However, coverage rates of about 0.25 pounds/ft² (lb/ft²) to about 0.5 lb/ft² are common.

After broadcasting the aggregate flooring material at 120, the base layer 20 is allowed to at least partially cure. Depending on the chemistry of the base layer material and the ambient conditions, curing may take anywhere from a few hours to 10 hours or more.

After curing of the base layer 20, the loose aggregate flooring material, e.g., quartz granules 35, may be removed from the base layer at 130 (see FIG. 2) by sweeping, vacuuming, etc. If desired, processes 110, 120, and 130 may optionally be repeated. That is, a second base layer (not shown) may be applied over the aggregate flooring material layer 30, and a second aggregate flooring material layer broadcast over the second base layer using the same or different coverage rates. Thus, greater floor coating thicknesses may ultimately be obtained.

Once the base layer(s) has cured and excess aggregate material removed from its surface, a UV-curable topcoat layer material (e.g., topcoat layer material 40 of FIG. 1) may be applied over the base layer(s) and aggregate material layer(s) at 140 with a squeegee or by other methods. A backroller may be used to evenly distribute the topcoat layer material. The thickness of the UV-curable topcoat layer material may vary depending on the application. While thicknesses of about 0.001 in to about 0.02 in are possible, coverage rates of about 100 ft²/gal to about 150 ft²/gal are desirable when using the Tennant ECO-DQF quartz granules described herein (e.g., resultant layer thickness of about 0.010 in to about 0.016 in). However, coverage rates up to about 550 ft²/gal are contemplated.

The time delay in application of the UV-curable topcoat layer 40 may be adjusted to ensure adequate bonding of the UV-curable topcoat layer 40 to the base layer/aggregate flooring material layers.

After application of the topcoat layer material, it may be cured by application of UV energy at 150 (see FIG. 3). The floor coating is then generally immediately ready for traffic.

If less texture of the floor coating is desired, processes 140 and 150 may be repeated. That is, a second topcoat layer (not shown) may be applied over the first topcoat layer 40 and cured. Such subsequent applications of the topcoat layer material may be of the same or different coverage densities, e.g., about 100 ft²/gal to about 200 ft²/gal. Unless second applications of the topcoat layer material are repeated soon after curing of the first UV-curable topcoat layer though, e.g., within about 4 hours, additional surface preparation of the first topcoat layer (e.g., sanding) may be required.

Floor coatings and methods in accordance with the present invention may provide numerous benefits over other floor coatings known in the art. For example, by using a cured base layer or underlay (e.g., base layer 20 of FIG. 1) with a UV-curable topcoat layer (e.g., topcoat layer 40 of FIG. 1), a relatively thick floor coating may be obtained. Moreover, the UV-curable topcoat layer 40 of the present invention may be relatively quick-curing, permitting resumption of normal floor traffic more quickly than with other aggregate floor systems.

Floor coatings applied in accordance with the present invention may significantly reduce coating discoloration, e.g., yellowing, a problem common with many other epoxy resin base layers. This resistance to discoloration may be attributable to many factors. For instance, the UV-curable topcoat layer itself is UV-stable after curing and may provide a filtering effect. Further, discoloration of the epoxy resin base layer may be substantially reduced due to factors such as the blocking effect of the aggregate flooring material. That is, when the base layer is substantially or completely covered by quartz particles, little light may actually reach the base layer. To further improve the ability of the coating to resist discloration, non-yellowing aggregates may be used. Due to its ability to resist discoloration, aggregate floor coatings in accordance with the present invention may be used in sun-exposed areas.

Another potential advantage of the present floor coatings is the low energy required for UV curing. That is, when UV topcoat layers that are curable with the dual wavelength curing methods described herein are used, little curing energy may be required and, thus, little shrinkage of the coating may occur. Therefore, aggregate floor coatings as described herein may be particularly advantageous for coating surfaces that are adverse to shrinkage, e.g., vinyl. Moreover, low power requirements permit curing of aggregate floor coatings in accordance with the present invention using a curing apparatus that is powered by conventional low-power sources, e.g., a 120V AC, 15 amp outlet or a small generator.

Yet another potential advantage of the present invention is that scratches in the topcoat layer may be easily and quickly repaired. For example, a scratch may be repaired by simply sanding the scratch, reapplying the UV-curable topcoat layer material to a localized area, and UV-curing the localized area.

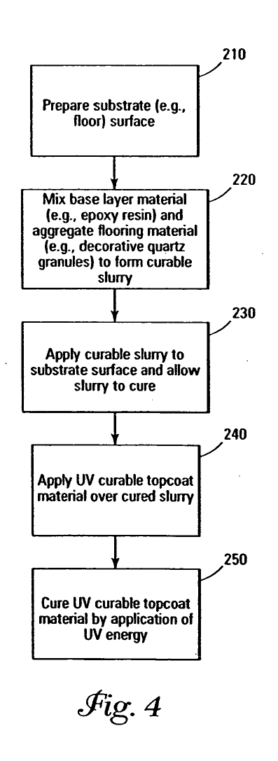

Other embodiments of the invention are also possible. For example, FIG. 4 illustrates an embodiment wherein the base layer material and the aggregate flooring material are mixed to form a base layer slurry prior to application. In this embodiment, the floor is cleaned/prepared at 210 in a known manner. The base layer material is then mixed with the aggregate flooring material, e.g., the base layer material 20 is mixed with the quartz granules 35, to form a slurry at 220. The slurry is then applied to the substrate or floor surface at 230 in a known manner, e.g., rolling, and allowed to cure. The UV-curable topcoat layer material 40, as already described herein, is applied at 240 after the base layer has at least partially cured and, more preferably, fully cured. The UV topcoat layer may then be cured at 250 by application of UV energy as already described herein.

The complete disclosure of the patents, patent documents, and publications cited in the Detailed Description of Exemplary Embodiments and elsewhere herein are incorporated by reference in their entirety as if each were individually incorporated.

Exemplary embodiments of the present invention are described above. Those skilled in the art will recognize that many embodiments are possible within the scope of the invention. For instance, other base layers, aggregate flooring materials, and UV-curable topcoats may be used. Other variations, modifications, and combinations of the coatings and processes described and illustrated herein can certainly be made and still fall within the scope of the invention. Thus, the invention is limited only by the following claims, and equivalents thereto.

What is claimed is:

1. A method for applying a coating to a floor, the method comprising:
applying at least one curable base layer material and particles of aggregate material to the floor;
curing the at least one curable base layer material to form an at least partially cured base layer on the floor;
applying an ultraviolet-curable topcoat layer material over the at least partially cured base layer and the particles of aggregate material;
traversing the floor with a movable source of ultraviolet energy; and
curing the ultraviolet-curable topcoat layer material, via exposure to the movable source of ultraviolet energy, to form an ultraviolet-cured topcoat layer.

2. The method of claim 1, wherein applying the at least one curable base layer material and the particles of aggregate material to the floor comprises:
applying the at least one curable base layer material to the floor; and
distributing the particles of aggregate material over the at least one curable base layer material.

3. The method of claim 1, wherein applying the at least one curable base layer material and the particles of aggregate material to the floor comprises:
mixing the at least one curable base layer material with the particles of aggregate material to form a base layer slurry; and
applying the base layer slurry to the floor.

4. The method of claim 1, wherein applying the at least one curable base layer material and particles of aggregate material comprises at least partially embedding the particles of aggregate material in the at least one curable base layer material.

5. The method of claim 1, further comprising removing excess particles of aggregate material prior to applying the ultraviolet-curable topcoat layer material.

6. The method of claim 1, wherein the particles of aggregate material comprise quartz granules.

7. The method of claim 1, wherein the particles of aggregate material comprise paint flecks.

8. The method of claim 1, wherein the at least one curable base layer material is curable by exposure to one or more of ambient temperature, humidity, and visible light.

9. A method for applying a coating to a floor, the method comprising:
applying a curable base layer material to the floor;
distributing an aggregate material over an upper surface of the curable base layer material;
applying an ultraviolet-curable topcoat layer material over the aggregate material and the curable base layer material;
traversing the floor with a movable source of ultraviolet energy; and
curing the ultraviolet-curable topcoat layer material by exposure to the movable source of ultraviolet energy to form an ultraviolet-cured topcoat layer.

10. The method of claim 9, further comprising at least partially curing the curable base layer material before applying the ultraviolet-curable topcoat layer material.

11. The method of claim 10, wherein distributing the aggregate material occurs before complete curing of the curable base layer material.

12. The method of claim 9, further comprising removing excess aggregate material prior to applying the ultraviolet-curable topcoat layer material.

13. The method of claim 9, further comprising:
applying a second curable base layer material over the aggregate material; and
distributing a second aggregate material over an upper surface of the second curable base layer material.

14. The method of claim 9, further comprising:
applying a second ultraviolet-curable topcoat layer material over the ultraviolet-cured topcoat layer; and
curing the second ultraviolet-curable topcoat layer material.

15. The method of claim 9, wherein distributing the aggregate material comprises distributing a granular quartz material to substantially cover the upper surface of the curable base layer material.

16. The method of claim 9, further comprising preparing the floor prior to applying the curable base layer material.

17. A method for applying a coating to a floor, the method comprising:
mixing a curable base layer material with an aggregate flooring material to form a slurry;
applying the slurry to the floor;
applying an ultraviolet-curable topcoat layer material over the slurry; and
curing the ultraviolet-curable topcoat layer material by application of ultraviolet energy emitted from an ultraviolet energy source passing over the floor.

18. The method of claim 17, further comprising at least partially curing the slurry before applying the ultraviolet-curable topcoat layer material.

19. The method of claim 17, wherein the aggregate flooring material comprises a granular quartz material.
